(19) United States
(12) Patent Application Publication
(10) Pub. No.: US 2014/0178687 A1
(43) Pub. Date: Jun. 26, 2014

(54) Monofilament Fibers Made From a Polyoxymethylene Composition

(71) Applicant: Ticona LLC, Florence, KY (US)

(72) Inventors: Robert Gronner, Erlanger, KY (US); Arvind Karandikar, Morristown, TN (US); Kaushik Chakrabarty, Florence, KY (US); David McIlroy, Cincinnati, OH (US)

(73) Assignee: Ticona LLC, Florence, KY (US)

(21) Appl. No.: 14/137,494

(22) Filed: Dec. 20, 2013

Related U.S. Application Data
(60) Provisional application No. 61/739,981, filed on Dec. 20, 2012.
(60) Provisional application No. 61/783,925, filed on Mar. 14, 2013.

(51) Int. Cl. D01F 6/94; A46B 9/00; A01K 89/015

(52) U.S. Cl. CPC D01F 6/94; A01K 89/015; A46B 9/00
USPC 428/401; 525/453; 524/377; 162/348; 242/322; 15/159.1

(57) ABSTRACT

A monofilament fiber as described made from a polyoxymethylene polymer. Polyoxymethylene polymer can be blended with an abrasion additive in order to improve abrasion resistance. The polyoxymethylene polymer may be combined with a thermoplastic elastomer and a coupling agent. The fiber can be used as fishing line, as bristles for a brushing device, or the like.

### RELATED APPLICATIONS

The present application claims priority to U.S. Provisional Patent Application Ser. No. 61/739,981, filed on Dec. 20, 2012 and U.S. Provisional Patent Application Ser. No. 61/783,925, filed on Mar. 14, 2013, which are incorporated herein in their entirety by reference thereto.

### BACKGROUND

Polyoxymethylene polymers, which are also referred to as polyacetal polymers, are a class of high-performance polymers with good mechanical properties, such as stiffness and strength. In addition, polyoxymethylene polymers are chemically resistant and can be exposed to many different solvents including water. Polyoxymethylene polymers are also heat resistant and have relatively high melting points.

In view of their excellent balance of properties, polyoxymethylene polymers are used in many and diverse applications. The polymers, for instance, are typically used to mold plastic parts for use in different fields. Polyoxymethylene polymers, for instance, are used to produce different types of automotive parts and consumer appliance parts. Polyoxymethylene polymers also used to produce components for the electronics industry.

In addition to molded articles, polyoxymethylene polymers have also been used to produce fibers. For instance, U.S. patent application Ser. No. 13/325,171, which is incorporated herein by reference, discloses fibers made from a polyoxymethylene polymer for reinforcing concrete.

Although the '171 application identified above has provided great advancements in the art, further improvements are still needed in producing fibers from polyoxymethylene polymers and in producing various products made from the fibers. Problems have been experienced, for instance, in producing continuous monofilament fibers from polyoxymethylene polymers having a relatively large diameter. There is also a need for producing fibers made from a polyoxymethylene polymer that have improved properties, especially abrasion resistance.

### SUMMARY

In general, the present disclosure is directed to fibers made from a polyoxymethylene polymer with improved physical properties. In one embodiment, the fibers comprise continuous, monofilament fibers. In one embodiment, the fibers can be produced so as to have increased abrasion resistance. The diameter of the fibers can vary depending on the particular application. Of particular advantage, larger diameter fibers can be produced that have excellent physical properties.

In one embodiment, for instance, the present disclosure is directed to fibers having excellent abrasion resistance properties. For instance, the present disclosure is directed to a monofilament fiber made from a polymer composition comprising a polyoxymethylene polymer blended with an abrasion additive.

The abrasion additive, for instance, can comprise a polymer such as a polyether. In one embodiment, for instance, the abrasion additive may comprise polyethylene glycol, polypropylene glycol, or mixtures thereof. In addition or instead of a polyether polymer, the abrasion additive may comprise various other materials. For instance, the abrasion additive in other embodiments may comprise a polytetrafluoroethylene polymer that may be added in the form of a powder. In other embodiments, the abrasion additive may comprise a polyethylene wax, a bisstearamide, a silicone oil, or a graft copolymer of a low density polyethylene and a polystyrene-acrylonitrile. Each of the abrasion additives may be used alone or in combination with other abrasion additives. In one embodiment, the silicone oil may be present in the polymer composition in combination with another abrasion additive, such as the bisstearamide.

The abrasion additive is melt blended with the polyoxymethylene polymer. The abrasion additive is present in the fiber in an amount from about 0.05% by weight to about 5% by weight, such as from about 0.05% to 2% by weight. The abrasion additive may be present in the fiber in an amount sufficient for the fiber to have an abrasion resistance of at least about 5000 cycles prior to failure, when tested according to the wire-on-yarn test. When tested according to the yarn-on-yarn abrasion test, on the other hand, fibers made according to the present disclosure have at least about 90% retained tensile strength, such as at least about 92% retained tensile strength, such at least about 94% retained tensile strength, such as at least about 96% retained tensile strength. The retained tensile strength can be up to 100%.

Monofilament fibers made according to the present disclosure can be made having relatively large diameters or relatively small diameters. In one embodiment, the polyoxymethylene polymer is combined with a thermoplastic elastomer and a coupling agent. The thermoplastic elastomer slows the crystallization rate of the polyoxymethylene polymer in amounts sufficient for larger diameters to be formed. For instance, a polymer composition containing a polyoxymethylene polymer and from about 5% to about 15% by weight of a thermoplastic elastomer can be used to produce monofilament fibers having a diameter of from about 0.1 mm to about 1.0 mm and in one embodiment at a diameter greater than 0.3 mm.

In one embodiment, monofilament fibers can be produced that have a relatively small diameter, such as less than about 0.2 mm. In one embodiment, the small diameter fibers can be formed from a polymer composition containing a polyoxymethylene polymer in combination with a coupling agent and relatively low amounts of thermoplastic elastomer. The thermoplastic elastomer may be present in the polymer composition, for instance, in an amount less than about 5% by weight, such as less than about 4% by weight.

### BRIEF DESCRIPTION OF DRAWINGS

A full and enabling disclosure of the present invention is set forth more particularly in the remainder of the specification, including reference to the accompanying figures, in which:

FIG. 1 is a perspective view of one embodiment of a forming fabric that may be made in accordance with the present disclosure;

FIG. 2 is a perspective view of a spool of fishing line made in accordance with the present disclosure;

FIG. 3 is a perspective view of a tennis racket made in accordance with the present disclosure; and

FIG. 4 is a diagram of one embodiment of a process for forming fibers in accordance with the present disclosure.

### DETAILED DESCRIPTION

It is to be understood by one of ordinary skill in the art that the present discussion is a description of exemplary embodiments only, and is not intended as limiting the broader aspects of the present disclosure.

In general the present disclosure is directed to fibers made from a polymer composition containing a polyoxymethylene polymer. The polyoxymethylene polymer can be combined with different components in order to not only produce fibers having desired physical dimensions, but can also be combined with various components in order to improve various physical properties. Polyoxymethylene polymer compositions made according to the present disclosure, for instance, may be used to produce relatively large diameter fibers. In one embodiment, for instance, the fibers can have a diameter of greater than about 0.3 mm. In the past, various problems were experienced in extruding polyoxymethylene polymers to produce fibers having the above diameters.

It should be understood, however, that the polymer compositions of the present disclosure can produce fibers having any suitable diameter, including fibers having smaller diameters if desired.

In addition to being able to produce fibers having different physical dimensions, polymer fibers made according to the present disclosure can also have desirable physical properties. For instance, in one embodiment, an abrasion additive can be incorporated into the polymer composition for improving abrasion resistance properties. Polymer compositions can also be produced that have not only excellent fiber tenacity properties, but also excellent impact resistance.

Monofilament fibers made according to the present disclosure can be used in numerous and diverse applications. For instance, the monofilament fibers may be used to produce forming fabrics for paper substrates. The monofilament fibers can also be used to produce fishing line, brushing devices, filter cloth, support lines, braiding, ropes, netting, fishing nets, racket strings and the like.

In general, the polymer compositions of the present disclosure include a polyoxymethylene polymer combined with a coupling agent and at least one other polymeric component. In one embodiment, for instance, the polymer composition contains an abrasion additive that increases the abrasion resistance of the fibers made from the composition. In other embodiments, the polymer composition may contain a thermoplastic elastomer. The presence of the thermoplastic elastomer not only increases the flexibility of the fibers, but also allows for the production of fibers having relatively large diameters by controlling the rate of crystallization of the polyoxymethylene polymer.

The polyoxymethylene polymer used in the polymer composition may comprise a homopolymer or a copolymer. The polyoxymethylene polymer generally contains a relatively high amount of functional groups, such as hydroxyl groups in the terminal positions. More particularly, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 5 mmol/kg, such as at least 10 mmol/kg, such as at least 15 mmol/kg. In one embodiment, the terminal hydroxyl group content ranges from 18 to 500 mmol/kg, such as from about 50 mmol/kg to about 400 mmol/kg. In one particular embodiment, for instance, the terminal hydroxyl group content may be from about 100 mmol/kg to about 400 mmol/kg.

In addition to the terminal hydroxyl groups, the polyoxymethylene polymer may also have other terminal groups usual for these polymers. Examples of these are alkoxy groups, formate groups, acetate groups or hemiacetal groups. According to one embodiment, the polyoxymethylene is a homo- or copolymer which comprises at least 50 mol-%, such as at least 75 mol-%, such as at least 90 mol-% and such as even at least 97 mol-% of —CH₂O-repeat units.

In addition to having a relatively high terminal hydroxyl group content, the polyoxymethylene polymer according to the present disclosure can also optionally have a relatively low amount of low molecular weight constituents. As used herein, low molecular weight constituents (or fractions) refer to constituents having molecular weights below 10,000 dalton. In this regard, the polyoxymethylene polymer can contain low molecular weight constituents in an amount less than about 10% by weight, based on the total weight of the polyoxymethylene. In certain embodiments, for instance, the polyoxymethylene polymer may contain low molecular weight constituents in an amount less than about 5% by weight, such as in an amount less than about 3% by weight, such as even in an amount less than about 2% by weight.

The polyoxymethylene polymer can have any suitable molecular weight. In one embodiment, however, a relatively low molecular weight polymer may be used. The molecular weight of the polymer, for instance, can be from about 4,000 grams per mole to about 20,000 grams per mole. In other embodiments, however, the molecular weight can be well above 20,000 grams per mole, such as from about 20,000 moles per gram to about 100,000 grams per mole.

The preparation of the polyoxymethylene can be carried out by polymerization of polyoxymethylene-forming monomers, such as trioxane or a mixture of trioxane and a cyclic acetal such as dioxolane in the presence of ethylene glycol as a molecular weight regulator.

In one embodiment, a polyoxymethylene copolymer is used. The copolymer can contain from about 0.1 mol % to about 20 molal, and in particular from about 0.5 mol % to about 10 mol % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

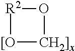

in which x is 0 or 1 and R2 is a C₂-C₄-alkylene group which, if appropriate, has one or more substituents which are C1-C4-alkyl groups, or are C1-C4-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers.

It is particularly advantageous to use copolymers composed of from 99.5 to 95 mol % of trioxane and of from 0.5 to 5 mol % of one of the above-mentioned comonomers.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2% by weight.

A heteropoly acid refers to polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

Hx[MmM′nOz]yH2O

wherein
M represents an element selected from the group consisting of P, Si, Ge, Sn, As, Sb, U, Mn, Re, Cu, Ni, Ti, Co, Fe, Cr, Th or Ce,
M′ represents an element selected from the group consisting of W, Mo, V or Nb,
m is 1 to 10,
n is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof.

Excellent results have been achieved with heteropoly acids selected from 12-molybdophosphoric acid (H3PMo12O40) and 12-tungstophosphoric acid (H3PW12O40) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfils the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH2)n-(COOR′)

wherein
n is an integer from 2 to 12, preferably 3 to 6 and
R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)2-CH—(CH2)m-CH—(COOR′)2

wherein
m is an integer from 0 to 10, preferably from 2 to 4 and
R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butanetetracarboxylic acid tetraethyl ester or butanetetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, dimethyl phthalic acid, dimethyl isophthalic acid, dimethyl terephthalic acid, diethyl phthalic acid, diethyl isophthalic acid, diethyl terephthalic acid, butanetetracarboxylic acid tetramethylestr and butanetetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 weight percent, preferably in an amount ranging from 0.01 to 5 weight percent, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain as a rule at least 80%, such as at least 90%, oxymethylene units. Such conventional polyoxymethylenes may be present in the composition as long as the resulting mixture maintains the desired amounts of hydroxyl terminated groups.

The polyoxymethylene polymer present in the composition can generally have a melt volume rate (MVR) or melt index of less than 50 cm 3/10 min, such as from about 1 to about 40 cm3/10 min, determined according to ISO 1133 at 190° C. and 2.16 kg. In general, the molecular weight of the polyoxymethylene polymer is related to the melt index. In particular, a higher melt index refers to a lower molecular weight, in one embodiment of the present disclosure, a polyoxymethylene polymer is incorporated into the polymer composition having a relatively low molecular weight.

In one embodiment, the polyoxymethylene polymer may have a meltflow rate of greater than about 7 g/10 min, such as greater than about 8 g/10 min. In an alternative embodiment, however, a polyoxymethylene polymer may be used that has a relatively low melt flow rate. For instance, the meltflow rate of the polymer can be less than about 5 g/10 min, such as less than about 3 g/10 min.

The amount of polyoxymethylene polymer present in the polymer composition of the present disclosure can vary depending upon the particular application. In one embodiment, for instance, the composition contains polyoxymethylene polymer in an amount of at least 50% by weight, such as in an amount greater than about 60% by weight, such as in an amount greater than about 65% by weight, such as in an amount greater than about 70% by weight. In general, the polyoxymethylene polymer is present in an amount less than about 99% by weight, such as in an amount less than about 95% by weight, such as in an amount less than about 90% by weight.

In addition to a polyoxymethylene polymer, polymer compositions made according to the present disclosure may contain a coupling agent and optionally an abrasion additive. The abrasion additive can increase the abrasion resistance properties of fibers, particularly monofilament fibers made from the polymer composition. In fact, abrasion additives in accordance with the present disclosure, can dramatically and unexpectedly improve the abrasion resistance of the fibers.

In one embodiment, the abrasion additive comprises a polyether. For instance, the abrasion additive may comprise a polyalkylene ether. Particular examples of abrasion additives that may be used include a polyethylene glycol, polypropylene glycol, or mixtures thereof. The molecular weight of the polymer may generally range from about 10,000 to about 100,000, such as from about 20,000 to about 50,000.

Of particular advantage, only minor amounts of the abrasion additive can significantly enhance abrasion resistance of fibers made from the composition. For example, in one embodiment, the abrasion resistance additive is present in an amount less than about 5% by weight, such as in an amount less than about 3% by weight, such as in an amount less than about 2% by weight, such as even in an amount less than about 1% by weight. The abrasion additive can impact abrasion resistance even when added in amounts generally greater than about 0.05% by weight. In one embodiment, for instance, the abrasion additive comprises polyethylene glycol and is present in the composition in an amount from about 0.05% to about 1% by weight.

In addition to a polyether, various other abrasion additives may be incorporated into the composition. The other abrasion additives as described below may be added with a polyether polymer or without a polyether polymer.

In one embodiment, the abrasion additive comprises a polymer of tetrafluoroethylene. For example, abrasion additives that may be used include PTFE powders with particle diameter range from 0.1 to 20 microns, and preferably from 0.1 to 10 micron. PTFE powders are described in U.S. Pat. No. 6,046,141, which is incorporated herein by reference. The amount of PTFE used may range from 0.1 to 10% by weight and preferably from 1 to 5% by weight.

In one embodiment, the abrasion additive comprises an oxidized polyethylene wax. For example, the abrasion additive may comprise an oxidized polyethylene wax, such as AC316A, Licowax PED 191, or mixtures thereof. The amount of oxidized polyethylene wax used may range from 0.01% to 1.0% by weight and preferably from 0.1 to 1.0% by weight.

In one embodiment, the abrasion additive comprises a bisstearamide. For example, the abrasion additive may comprise an N,N′-bis(stearoyl)ethylenediamine. Particular examples include Acrawax C, Licolub FA1 or mixtures thereof. The amount of bisstearamide used may range from 0.01% to 1.0% by weight and preferably from 0.1 to 1.0% by weight.

In one embodiment, the abrasion additive comprises a silicone oil. For instance, the abrasion additive may comprise an 30,000 cSt kinematic viscosity silicone oil. The kinematic viscosity of the oil may generally range from about 1000 to about 100,000 cSt, and preferably from about 10,000 to about 70,000 cSt. The amount of silicone oil used may range from 0.5 to 5.0% by weight and preferably from 1.0 to 2.0% by weight.

In one embodiment, the abrasion additive comprises a graft copolymer of LDPE and polystyrene-acrylonitrile (PSAN). For instance, the abrasion additive may comprise a 50:50 LDPE-graft-PSAN copolymer, in which the styrene:acrylonitrile copolymer chains are comprised of a statistical ratio of 70% styrene and 30% acrylonitrile. Particular examples of LDPE-graft-PSAN copolymer include Modiper A 1401. The amount of this polymer used may range from 0.5 to 10% by weight and preferably from 1.0 to 5.0% by weight.

The above described abrasion additives may be used alone or in combination. For instance, a silicone oil can be combined with any of the other abrasion additives, such as the bisstearamide.

When the abrasion additive is present in the polymer composition, fibers made from the polymer composition can have an abrasion resistance that is at least 50% greater, such as at least 100% greater than identical fibers made without containing the abrasion additive. As used herein, the abrasion resistance for monofilament fibers can be measured according to the “wire-on-yarn test” using metal wire as an abrading substrate under 1.5 kg of tension loading. The abrading substrate has a diameter of 1.35 mm and contacts the sample being tested at a 35° angle. The monofilament sample being abraded is wrapped once around the wire and tensioned with a load of 350 grams. The sample is raised and lowered using a reciprocating drive with a frequency of 52 cycles per minute. Cycles to failure is measured. The abrasion test for monofilament fibers is also described in the examples below. Monofilament fibers made according to the present disclosure can have an abrasion resistance as measured above of greater than about 5,000 cycles, such as greater than about 6,000 cycles, such as even greater than about 7,000 cycles (generally less than 15,000 cycles).

The fibers made according to the present disclosure can also be tested according to the “yarn-on-yarn test”. The yarn-on-yarn abrasion test is described in an article entitled “Yarn-on-Yarn Abrasion Test,” Technical Notes 18, January 2005, published by Tension Technology International Ltd. The yarn-on-yarn abrasion test is described in ASTM Test D-6611 and in Cordage Institute Test Number 1503. According to the present disclosure, testing is after 500 cycles at 109 gf tension, dry, 60 cycles per minute, followed by tensile testing to establish residual strength of samples. The results are measured in percent retained tensile strength. Fibers made according to the present disclosure can have a percent retained tensile strength of greater than about 90%, such as greater than about 92%, such as greater than about 94%, such as even greater than about 96%.

In one embodiment, the polymer composition can also contain a thermoplastic elastomer. The thermoplastic elastomer, which may also be referred to as an impact modifier, can be present in the composition alone or in combination with the abrasion additive. When present, the thermoplastic elastomer is combined with a coupling agent that can couple the elastomer with the polyoxymethylene polymer.

Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE E), thermoplastic polyimide elastomers (TPE A) and in particular thermoplastic polyurethane elastomers (TPE-U). The above thermoplastic elastomers have active hydrogen atoms which can be reacted with the coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used either alone or in combination with other elastomers. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(ε-caprolactone)diol; and polyether diols such as poly(tetramethylene ether)glycol, polypropylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C2-C6 aliphatic dials such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

When a thermoplastic elastomer is present in the polymer composition the amount added to the composition can vary depending on various factors. For instance, the amount of thermoplastic elastomer incorporated in to the composition, can depend on the size of fibers that are desired. For instance, when producing smaller diameter fibers, in one embodiment, it may be preferable to add lesser amounts of the thermoplastic elastomer. For example, in one embodiment, when producing monofilament fibers having a diameter of about 0.2 mm or less, the thermoplastic elastomer may be present in an amount from about 0.5% to less than 5%, such as from about 1% to about 4.5%, such as from about 2% to about 4% by weight.

When producing larger diameter fibers having a diameter greater than 0.2 mm, greater amounts of the thermoplastic elastomer may be incorporated into the composition. In fact, the presence of the thermoplastic elastomer can make it possible to produce the larger diameter fibers. When producing monofilament fibers having a diameter of greater than about 0.3 mm, the thermoplastic elastomer may be present in the composition in an amount greater than about 5% by weight, such as in an amount greater than about 10% by weight. For instance, the thermoplastic elastomer may be present in an amount from about 5% to about 30% by weight, such as in an amount from about 5% to about 15% by weight. The diameter can generally be less than 3 mm, such as less than 2 mm, such as less than 1 mm.

The coupling agent present in the polymer composition comprises a coupling agent capable of coupling the polyoxymethylene polymers together or with other components. In order to form bridging groups between the polyoxymethylene polymer and the elastomer, a wide range of polyfunctional, such as trifunctional or bifunctional coupling agents, may be used. The coupling agent may be capable of forming covalent bonds with the terminal hydroxyl groups on the polyoxymethylene polymer and with active hydrogen atoms on the thermoplastic elastomer. In this manner, the elastomer becomes coupled to the polyoxymethylene through covalent bonds.

In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclonexylene diisocyanate (HTDI); 2,4-methyloyelohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatomethylcyclohexane isocyanate; bis(isocyanatomethyl)-cyclohexane diisocyanate; 4,4′-bis(isocyanatomethyl)dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcycloh-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

The polymer composition generally contains the coupling agent in an amount from about 0.1% to about 10% by weight. In one embodiment, for instance, the coupling agent is present in an amount greater than about 0.5% by weight, such as in an amount greater than 1% by weight. In one particular embodiment, the coupling agent is present in an amount from about 0.2% to about 5% by weight. To ensure that the elastomer has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

In one embodiment, a formaldehyde scavenger may also be included in the composition. The formaldehyde scavenger, for instance, may be amine- or amide-based and may be present in an amount less than about 1% by weight.

The polymer composition of the present disclosure can optionally contain a stabilizer and/or various other known additives. Such additives can include, for example, antioxidants, acid scavengers, UV stabilizers or heat stabilizers. In addition, the molding material or the molding may contain processing auxiliaries, for example adhesion promoters, lubricants, nucleating agents, demolding agents, fillers, reinforcing materials or antistatic agents and additives which impart a desired property to the molding material or to the molding, such as dyes and/or pigments.

Examples of antioxidants include, for instance, sterically hindered phenol compounds. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), 3,5-di-tart-butyl-4-hydroxytoluene (Lowinox BHT, Chemtura) and n-octadecyl-β-(4-hydroxy-3,5-di-tert-butyl-phenyl)propionate. In one embodiment, for instance, the antioxidant comprises tetrakis[methylene(3,5-di-tert-butyl-4-hydroxyhydrocinnamate)]methane. The antioxidant may be present in the composition in an amount less than 2% by weight, such as in an amount from about 0.1 to about 1.5% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). UV stabilizers or absorbers that may be present in the composition include benzophenones or benzotriazoles.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm.

In order to form fibers in accordance with the present disclosure, the polymeric composition can be melt blended together and extruded.

In one embodiment, the different components can be melted and mixed together in a conventional single or twin screw extruder. The melt blending of the components is typically carried out at temperatures of from about 170° C. to 240° C., such as from about 190° C. to 235° C., and the duration of mixing is typically from about 0.5 to about 60 minutes.

For instance, extruded strands may be produced by an extruder which are then pelletized and stored for later use. Prior to compounding, the polymer components may be dried to a moisture content of about 0.05 weight percent or less. If desired, the pelletized compound can be ground to any suitable particle size, such as in the range of from about 100 microns to about 500 microns.

For purposes of this disclosure, a monofilament fiber is herein defined to refer to a fiber that has been extruded or spun from a melt as an individual fiber. That is, while the extruded monofilament fiber can be subjected to post-extrusion processing (e.g., quenching, drying, drawing, heat processing, finish application, etc.), the fiber will be initially extruded or spun from a melt in the individual fiber form. A tape fiber, on the other hand, is intended to refer to fibers that have been formed from a larger section during post-extrusion processing. For example, the term ‘tape fiber’ can encompass fibers that have been cut or otherwise separated from a larger extruded film, for instance an extruded flat film or a film extruded as a cylinder. In general, tape fibers can have a clear delineation between adjacent sides of the fibers, with a clear angle between the adjacent sides, as they can usually be formed by cutting or slicing individual fibers from the larger polymer section, but this is not a requirement. For example, in one embodiment, individual tape fibers can be pulled from a larger polymeric piece, and thus may not show the sharper angles between adjacent edges that may be common to a tape fiber that has been cut from a larger piece of material.

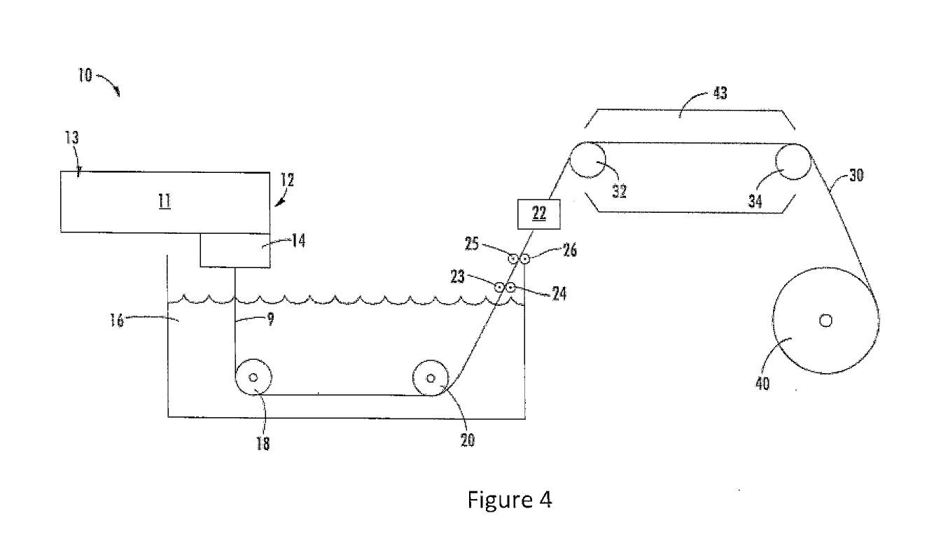

Referring to FIG. 4, one embodiment of a POM fiber forming process generally 10 is schematically illustrated. According to the illustrated embodiment, a melt of a POM composition can be provided to an extruder apparatus 12.

The extruder apparatus 12 can be a melt spinning apparatus as is generally known in the art. For example, the extruder apparatus 12 can include a mixing manifold 11 in which a POM composition can be mixed and heated to form a molten composition. The formation of the molten mixture can generally be carried out at a temperature as described above, e.g., from about 170° C. to about 240° C.

Optionally, to help ensure the fluid state of the molten mixture, in one embodiment, the molten mixture can be filtered prior to extrusion. For example, the molten mixture can be filtered to remove any fine particles from the mixture with a filter of between about 10 and about 360 gauge.

Following formation of the molten mixture, the mixture can be conveyed under pressure to the spinneret 14 of the extruder apparatus 12, where it can be extruded through an orifice to form the fiber 9. The mixture can be extruded as either a monofilament fiber 9, as shown in FIG. 4, or as a film, for instance in either a sheet orientation or in a cylindrical orientation, and cut or sliced into individual tape fibers during post-processing of the film. In particular, while the majority of the ensuing discussion is specifically directed to the formation of a monofilament fiber, it should be understood that the below described processes are also intended to encompass the formation of a film for subsequent formation of a tape fiber.

The spinneret 14 can generally be heated to a temperature that can allow for the extrusion of the molten polymer while preventing breakage of the fiber 9 during formation. For example, in one embodiment, the spinneret 14 can be heated to a temperature of between about 170° C. and about 210° C. In one embodiment, the spinneret 14 can be heated to the same temperature as the mixing manifold 11. This is not a requirement of the process, however, and in other embodiments, the spinneret 14 can be at a different temperature than the mixing manifold 11. For example, in one embodiment, increasing temperatures can be encountered by the mixture as it progresses from the inlet to the mixing manifold to the spinneret. In one embodiment, the mixture can progress through several zones prior to extrusion.

When forming a monofilament fiber, the spinneret orifice through which the polymer can be extruded can generally be less than about 5 mm in maximum cross-sectional width (e.g., diameter in the particular case of a circular orifice). For example, in one embodiment, the spinneret orifices can be between about 0.5 mm and about 4 mm in maximum cross-sectional width.

When forming a film, the film die can be of any suitable orientation and length, and can be set to a thickness of less than about 5 mm. For example, in one embodiment, the film die can be set at a width of between about 1 mm and about 2.5 mm.

Following extrusion of the polymer, the un-drawn fiber 9 can be quenched, for instance in a liquid bath 16 and directed by roll 18. The liquid bath 16 in which the fiber 9 can be quenched can be a liquid in which the polymer is insoluble. For example, the liquid can be water, ethylene glycol, or any other suitable liquid as is generally known in the art. Generally, in order to encourage formation of fibers with substantially constant cross-sectional dimensions along the fiber length, excessive agitation of the bath 16 can be avoided during the process. Of course, a liquid quench is not a requirement of disclosed processes, and in another embodiment, the un-drawn fiber can be quenched in an air quench, as is known.

Roll 18 and roll 20 can be within bath 16 and convey fiber 9 through the bath 16. Dwell time of the material in the bath 16 can vary, depending upon particular materials included in the polymeric material, particular line speed, etc. In general, fiber 9 can be conveyed through bath 16 with a dwell time long enough so as to ensure complete quench, i.e., crystallization, of the polymeric material. For example, in one embodiment, the dwell time of the material in the bath 16 can be between about 30 seconds and about 2 minutes. The bath can be at a temperature of from about 150° F. to about 190° F.

At or near the location where the fiber 9 exits the bath 16, excess liquid can be removed from the fiber 9. This step can generally be accomplished according to any process known in the art. For example, in the embodiment illustrated in FIG. 4, the fiber 9 can pass through a series of nip rolls 23, 24, 25, 26 to remove excess liquid from the fiber. Other methods can be alternatively utilized, however. For example, in other embodiments, excess liquid can be removed from the fiber 9 through utilization of a vacuum, a press process utilizing a squeegee, one or more air knives, and the like.

According to another embodiment, the extruded fiber can be quenched according to an air cooling procedure. According to this embodiment, an extruded fibers can be carried out under an air flow at a pre-determined temperature, for instance between about 30° C. and about 80° C., or about 50° C. in one embodiment.

In one embodiment, a lubricant can be applied to the fiber 9. For example, a spin finish can be applied at a spin finish applicator chest 22, as is generally known in the art. In general, a lubricant can be applied to the fiber 9 at a low water content. For example, a lubricant can be applied to the fiber 9 when the fiber is at a water content of less than about 75% by weight. Any suitable lubricant can be applied to the fiber 9. For example, a suitable oil-based finish can be applied to the fiber 9, such as Lurol PP-912, available from Ghoulston Technologies, Inc. Addition of a finishing or lubricant coat on the fiber can, in some embodiments, improve handling of the fiber during subsequent processing and can also reduce friction and static electricity buildup on the fiber.

After quenching of the fiber 9 and any optional process steps, such as addition of a lubricant for example, the fiber can be drawn while applying heat. For example, in the embodiment illustrated in FIG. 4, the fiber 9 can be drawn in an oven 43. Additionally, in this embodiment, the draw rolls 32, 34 can be either interior or exterior to the oven 43, as is generally known in the art. In another embodiment, rather than utilizing an oven as the heat source, the draw rolls 32, 34 can be heated so as to draw the fiber while it is heated. In another embodiment, the fiber can be drawn over a hotplate heated to a similar temperature or by passing through a heated liquid bath.

The fiber can be drawn in a first (or only) draw at a high draw ratio. For example, the fiber 9 can be drawn with a draw ratio (defined as the ratio of the speed of the second or final draw roll 34 to the first draw roll 32) of greater than about 5. For instance, in one embodiment, the draw ratio of the first (or only) draw can be greater than about 8. In another embodiment, the draw ratio can be up to about 10. Additionally, the fiber can be wrapped on the rolls 32, 34 as is generally known in the art. For example, in one embodiment, between about 5 and about 15 wraps of the fiber can be wrapped on the draw rolls.

A multi-stage draw can optionally be utilized. For instance, in a two stage draw, a fiber can be drawn to about 3 to about 15 times the original length in a first stage. In a second stage draw, the fiber can be drawn from about 1.05 to about 6 times the length of the fiber following the first stage draw, or from about 1.05 to about 2 times the length of the fiber following the first stage draw in another embodiment. The second draw can generally be carried out at a temperature that is higher than the temperature of the first stage draw.

Multi-stage drawing processes can be carried out in similar or different environments. For instance, a first stage draw can be carried out in a heated oven, and a second stage can be carried out in a heated liquid bath. Multi-stage draws can include two, three, or higher numbers of stages can be utilized. In one embodiment, a three stage draw can be used in which the fiber can be subjected to a first draw in air, a second draw in a heated aqueous bath and a third draw in a heated organic solution (e.g., an oil).

While the embodiment of FIG. 4 utilizes a series of draw rolls for purposes of drawing the fiber, it should be understood that any suitable process that can place a force on the fiber so as to elongate the fiber following the quenching step can optionally be utilized. For example, any mechanical apparatus including nip rolls, godet rolls, steam cans, air, steam, or other gaseous jets can optionally be utilized to draw the fiber.

Following the drawing step, the drawn fiber 30 can be cooled and wound on a take-up roll 40. In other embodiments, however, additional processing of the drawn fiber 30 may be carried out.

Optionally, the drawn fiber can be heat set. For example, the fiber can be relaxed or subjected to a very low draw ratio (e.g., a draw ratio of between about 0.7 and about 1.3) and subjected to a thermal treatment for a short period of time, generally less than about 3 minutes. In one embodiment, a heat setting step can be less than one minute, for example, about 0.5 seconds. This optional heat set step can serve to “lock” in the crystalline structure of the fiber following drawing. In addition, it can reduce heat shrinkage.

In one embodiment, after exiting the bath 16, the fiber can be fed through a first oven where the fiber is preheated at a temperature of from about 200° F. to about 340° F. After being preheated, the fiber can then be fed to a second oven at approximately the same temperature. While in the second oven, or directly after the second oven, the fiber can be fed through draw rolls for drawing the fiber. After the first draw stage, the fiber can then be fed to a third oven also at a temperature of from about 200° F. to about 340° F. After being heated in the third oven, the fiber can then be fed through further draw rolls for further drawing the fiber in a second stage. After the second stage draw, the fiber can then be fed to a fourth oven also at a temperature from about 200° F. to 340° F. In the fourth oven the fiber can be annealed. After annealing, the fiber can be wound onto a spool.

After the fibers are formed as described above, the fibers can be used in numerous and diverse applications. In one embodiment, for instance, the fibers may be used to produce a forming fabric for paper making processes. Forming fabrics generally refer to woven or knitted porous fabrics that are designed to receive an aqueous suspension of cellulose fibers. The suspension of fibers are fed onto the forming fabric for forming a paper sheet. Once the aqueous suspension of fibers is deposited on the fabric, water drains through the fabric leaving a wet paper web on the surface.

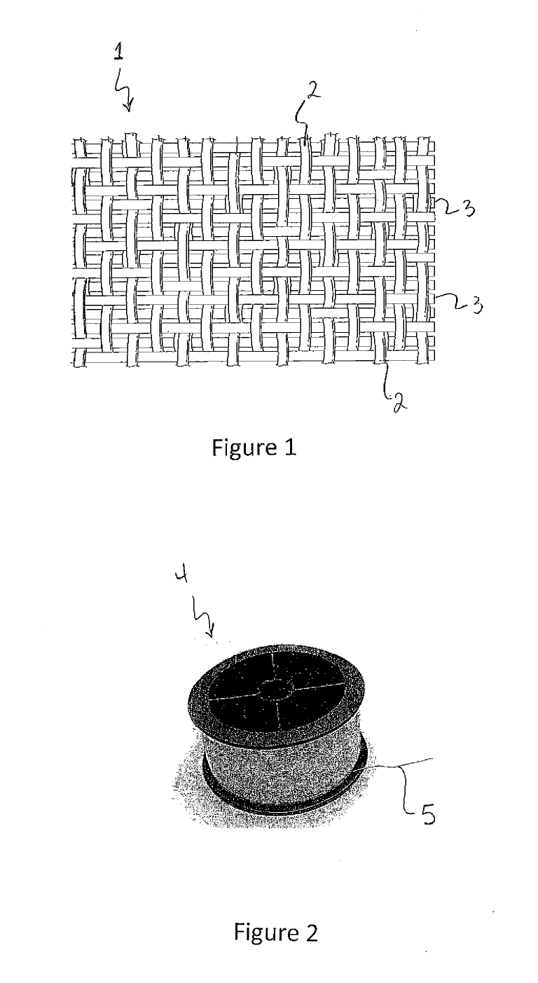

Referring to FIG. 1, for instance, one embodiment of a forming fabric 1 that may be made in accordance with the present disclosure is illustrated. As shown, the forming fabric 1 includes warp fibers 2 that extend in a machine direction and weft fibers 3 that extend in a cross-machine direction. Forming fabrics can be woven in complicated patterns in order to enhance various properties. In accordance with the present disclosure, all or any of the fibers may be made from the monofilament fibers as described above. Of particular advantage, monofilament fibers made in accordance with the present disclosure that contain primarily a polyoxymethylene polymer are not only heat resistant but are also water resistant and hydrolytically stable. The polyoxymethylene fibers, for instance, may comprise the warp fibers 2 and/or the weft fibers 3. The polyoxymethylene fibers may form the top surface of the fabric, or may be used so only to comprise the bottom surface of the fabric.

In addition to forming fabrics for papermaking processes, the fibers of the present disclosure may also be used to produce various sporting goods. In one embodiment, for instance, the monofilament fiber may be used as fishing line.

Referring to FIG. 2, for instance, a spool 4 of a fishing line 5 is illustrated. In this embodiment, the fishing line 5 comprises a continuous monofilament fiber that has been wound around the spool 4. The fishing line can be dispensed from the spool and incorporated into a reel that is then attached to a fishing pole.

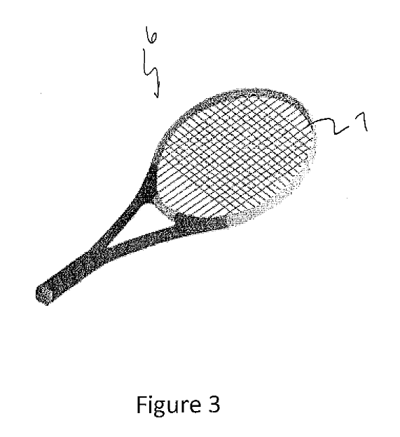

In still another embodiment, the fibers of the present disclosure may be used to produce racket strings. For instance, referring to FIG. 3, a tennis racket 6 is illustrated that includes racket strings 7 that may be made in accordance with the present disclosure.

In yet another embodiment, the fibers may be incorporated into a brushing device. For instance, the fibers may be used to form bristles on the brushing device.

In another embodiment, the fibers may be used to produce a filter material. For instance, the fibers may be woven into a fabric, knitted into a fabric, or used to form a nonwoven material that may be designed to filter fluids, such as liquids or gases.

The polyoxymethylene fibers of the present disclosure can be have a useful combination of properties and/or physical dimensions. Fibers made in accordance with the present disclosure, for instance, can have excellent physical and mechanical properties. The fibers, for instance, may have a break elongation of from about 10% to about 30%. The fibers can also have a break tenacity of greater than about 4 g/den, such as greater than about 6 g/den, such as even greater than about 8 g/den. The break tenacity, for instance, may be from about 4 g/den to about 15 g/den, such as from about 6 g/den to about 10 g/den.

Fibers may be made from polyoxymethylene formulations. The formulations according to the present disclosure can have a break stress of greater than about 30 MPa, such as greater than about 35 MPa such as greater than about 40 MPa. The break stress is generally less than about 300 MPa, such as less than about 70 MPa. The break strain of the formulations can be from about 10% to about 70%, such as from about 30% to about 70%. In one embodiment, the formulations can have a tensile modulus of greater than about 1400 MPa, such as greater than about 1600 MPa, such as greater than about 1800 MPa, such as greater than about 2000 MPa. The tensile modulus is generally less than about 5000 MPa, such as less than about 4500 MPa.

The present disclosure may better be understood with reference to the following examples.

### Example 1

The following experiments were conducted in order to show some of the benefits and advantages of compositions made according to the present disclosure.

First, polyoxymethylene (POM) compositions were made with varying amounts of a thermoplastic polyurethane elastomer (TPU). The other components of the formulations were held constant and included polyethylene glycol (PEG), methylene diphenyl isocyanate (MDI), wax, a anti-oxidant comprising triethyleneglycol-bis[3-(3-t-butyl-4-hydroxy-5-methylphenyl)propionate], a lubricant comprising magnesium stearate, and a stabilizer comprising a polyimide resin.

The polyoxymethylene was hydroxy functional wherein about 85% of the terminal groups were hydroxy groups. Also, the polymer had a melt flow rate of 2.3 g/10 min at a temperature of 190° C. and at a load of 2.16 kilograms.

The following table describes the eight different POM formulations.

TABLE 1
Formulation Examples

| Sample | | | | | | Anti- | | Stabi- |
|---|---|---|---|---|---|---|---|---|
| Number | POM | TPU | PEG | MDI | Wax | oxidant | Lubricant | lizer |
| 1 | 98.54 | 0 | 0.14 | 0.8 | 0.2 | 0.2 | 0.07 | 0.05 |
| 2 | 96.04 | 2.5 | 0.14 | 0.8 | 0.2 | 0.2 | 0.07 | 0.05 |
| 3 | 93.54 | 5 | 0.14 | 0.8 | 0.2 | 0.2 | 0.07 | 0.05 |
| 4 | 91.04 | 7.5 | 0.14 | 0.8 | 0.2 | 0.2 | 0.07 | 0.05 |
| 5 | 88.54 | 10 | 0.14 | 0.8 | 0.2 | 0.2 | 0.07 | 0.05 |
| 6 | 83.54 | 15 | 0.14 | 0.8 | 0.2 | 0.2 | 0.07 | 0.05 |
| 7 | 78.54 | 20 | 0.14 | 0.8 | 0.2 | 0.2 | 0.07 | 0.05 |
| 8 | 68.54 | 30 | 0.14 | 0.8 | 0.2 | 0.2 | 0.07 | 0.05 |

The formulations described above were then tested for their tensile modulus, break stress, break strain, impact strength, crystallization time, and melting point.

The tensile properties were tested according to ISO Test No. 527. The Modulus and strength measurements, i.e. break stress and break strain, were made on the same test strip sample-ISO Type 1A. The testing temperature was 23° C., and the testing speed was 1 mm/min to measure the modulus and 50 mm/min to measure the stress and strain.

The impact strength was tested according to ISO Test No. 179-1, using a bar cut from the center of a multi-purpose specimen, notch type “A”, and tested edgewise. The testing temperature was 23° C., and the impact velocity was 2.9 m/s.

The isothermal crystallization time (ICT) was measured using a differential scanning calorimeter. The formulation was heated to above its melting point and then rapidly cooled to and held isothermal at a temperature below its melting point and above its recrystallization point. The isothermal crystallization half-time (ICT) is the time taken to reach peak heat flow during isothermal recrystallization

The melting point was measured using a differential scanning calorimeter. The formulation was heated and the melting point was the temperature at which the heat flow was at its maximum during the melting process.

The following table lists the results from these tests.

TABLE 2
Mechanical & Thermal Properties of Formulations

| | Tensile | Break | Break | | | |
|---|---|---|---|---|---|---|
| Sample | Modulus | Stress | Strain | Impact Strength | ICT | MP |
| Number | (MPa) | (MPa) | (%) | (kJ/m²) | (min) | (° C.) |
| 1 | 2753 | 57.2 | 39.4 | 5.9 | 4.8 | 168.6 |
| 2 | 2299 | 47.7 | 36.5 | 13.8 | 8.4 | 167.0 |
| 3 | 2256 | 47.2 | 35.9 | 12.7 | 9.2 | 168.7 |
| 4 | 2033 | 45.9 | 40.6 | 11.8 | 10.3 | 168.6 |
| 5 | 1933 | 41.9 | 49.0 | 15.4 | 12.2 | 167.7 |
| 6 | 1590 | 35.9 | 75.0 | 24.0 | 14.0 | 166.1 |
| 7 | 1456 | 33.1 | 61.1 | 30.4 | 20.9 | 167.4 |
| 8 | 1095 | 32.1 | 339.2 | 31.3 | 18.6 | 167.3 |

Notes:
(1) Resin isothermal crystallization half-time was measured at 152° C. Using differential scanning calorimetry

The compositions described in Table 1 were then extruded into monofilament fibers. The fibers were tested for break tenacity, break elongation, and tensile modulus.

The tensile properties of the monofilaments were tested according to ASTM D2256. Modulus and strength measurements were made on the same test sample which had a gage length of 10 inches. The testing temperature was 23° C., and the testing speed was 10 in/min.

The following table lists the results from these tests.

TABLE 3
Mechanical Properties of Monofilaments

| Fiber | Formulation | Nominal | Break | Break | Tensile |
|---|---|---|---|---|---|
| Sample | Sample | Diameter | Tenacity | Elongation | Modulus |
| Number | Number | (mm) | (gpd) | (%) | (gpd) |
| 1 | 1 | 0.2 | 7.1 | 22 | 36 |
| 2 | 3 | 0.2 | 6.0 | 21 | 31 |
| 3 | 3 | 0.4 | 5.7 | 25 | 27 |
| 4 | 3 | 0.6 | 3.9 | 20 | 25 |
| 5 | 5 | 0.2 | 6.9 | 19 | 38 |
| 6 | 5 | 0.4 | 5.3 | 19 | 33 |
| 7 | 5 | 0.6 | 4.6 | 22 | 28 |
| 8 | 8 | 0.2 | 6.7 | 22 | 35 |
| 9 | 6 | 0.6 | 4.1 | 21 | 25 |
| 10 | 7 | 0.2 | 5.7 | 17 | 36 |
| 11 | 7 | 0.4 | 4.6 | 17 | 31 |
| 12 | 7 | 0.6 | 4.3 | 17 | 28 |
| 13 | 8 | 0.2 | 4.2 | 16 | 29 |
| 14 | 8 | 0.4 | 4.6 | 15 | 31 |
| 15 | 8 | 0.6 | 3.4 | 13 | 29 |

### Example 2

The following experiments were conducted in order to demonstrate improved abrasion resistance and other properties of fibers made according to the present disclosure.

The polyoxymethylene compositions shown below in the table were made in an almost identical manner to Example 1. The difference, however, is that the amount of polyethylene glycol (PEG) is varied in these compositions whereas it was held constant in the first example. The formulations did not contain an elastomer.

The following table describes the three different POM formulations.

TABLE 4
Formulation Examples

| Sample | | | | | Anti- | | |
|---|---|---|---|---|---|---|---|
| Number | POM | PEG | MDI | Wax | oxidant | Lubricant | Stabilizer |
| 9 | 99.48 | 0 | 0 | 0.2 | 0.2 | 0.07 | 0.05 |
| 1 | 98.54 | 0.14 | 0.8 | 0.2 | 0.2 | 0.07 | 0.05 |
| 10 | 97.68 | 1 | 0.8 | 0.2 | 0.2 | 0.07 | 0.05 |

The compositions described in Table 4 above were then extruded into monofilament fibers. The fibers were tested in the same manner as described in example 1. However, in this case there was a special emphasis on abrasion resistance properties.

In this example, the monofilament abrasion testing used the wire-on-yarn test and was done in the following fashion. The abrading substrate was composed of a metal wire under 1.5 kg tension loading, having a diameter of 1.35 mm, and inclined at a 35 degree angle. The monofilament sample being abraded was wrapped once around the wire and tensioned with a load of 350 g. The sample was then raised and lowered using a reciprocating drive with a frequency of 52 cycles/min. Cycles to failure (CTF) were then measured.

The following table lists the results.

TABLE 5
Mechanical Properties of Monofilaments with Improved Abrasion
Resistance

| | Formulation | Nominal | Break | Break | Tensile | |
|---|---|---|---|---|---|---|
| Fiber Sample | Sample | Diameter | Tenacity | Elongation | Modulus | Abrasion |
| Number | Number | (mm) | (gpd) | (%) | (gpd) | CFT⁽¹⁾ |
| 16 | 9 | 0.2 | 5.2 | 20 | 34 | 2063 |
| 1 | 1 | 0.2 | 7.1 | 22 | 36 | 7352 |
| 17 | 10 | 0.2 | 5.6 | 20 | 33 | 7774 |

Note:
⁽¹⁾Abrasion cycles to failure

### Example 3

The following experiments were conducted in order to demonstrate improved abrasion resistance and other properties of fibers made according to the present disclosure.

The polyoxymethylene compositions shown below in the table were made in an almost identical manner to Example 1.

TABLE 6
Formulation Examples

| Sample | | | | | | Anti- | | Stabi- |
|---|---|---|---|---|---|---|---|---|
| Number | POM | TPU | PEG | MDI | Wax | oxidant | Lubricant | lizer |
| 9 | 99.48 | 0 | 0 | 0 | 0.2 | 0.2 | 0.07 | 0.05 |
| 11 | 98.68 | 0 | 0 | 0.8 | 0.2 | 0.2 | 0.07 | 0.05 |
| 1 | 98.54 | 0 | 0.14 | 0.8 | 0.2 | 0.2 | 0.07 | 0.05 |
| 12 | 98.18 | 0 | 0.5 | 0.8 | 0.2 | 0.2 | 0.07 | 0.05 |
| 2 | 96.04 | 2.5 | 0.14 | 0.8 | 0.2 | 0.2 | 0.07 | 0.05 |
| 13 | 95.68 | 2.5 | 0.5 | 0.8 | 0.2 | 0.2 | 0.07 | 0.05 |

The compositions described in Table 6 above were then extruded into monofilament fibers. The fibers were tested for mechanical properties in the same manner as described in example 1. The following table lists the results.

TABLE 7
Mechanical Properties of Monofilaments

| Fiber | Formulation | Nominal | Break | Break | Tensile |
|---|---|---|---|---|---|
| Sample | Sample | Diameter | Tenacity | Elongation | Modulus |
| Number | Number | (mm) | (gpd) | (%) | (gpd) |
| 16 | 9 | 0.2 | 5.2 | 20 | 34 |
| 18 | 11 | 0.2 | 7.6 | 16 | 55 |
| 1 | 1 | 0.2 | 7.1 | 22 | 36 |
| 19 | 12 | 0.2 | 6.0 | 22 | 34 |
| 20 | 2 | 0.2 | 6.0 | 17 | 43 |
| 21 | 13 | 0.2 | 6.1 | 18 | 39 |

The monofilament abrasion testing was done using a modified version of method CI-1503 used for yarn-on-yarn abrasion testing. The monofilament sample being abraded was wrapped around a pulley and once around itself and tensioned with a load of 109 g. The sample was raised and lowered using a reciprocating drive with a frequency of 60 cycles/min for 500 cycles. The tensile load required to break the sample after abrasion was measured, and compared to the tensile load required to break samples before abrasion. The ratio of the tensile load required to break the sample after abrasion to the tensile load required to break sample before abrasion is reported as retained tensile strength. A higher value is evidence of higher abrasion resistance.

The following table lists the results. Fibers 1, 19, 20 and 21 are made from polyoxymethylene formulations that contain PEG, and show improved retained tensile strength as compared to fibers 16 and 18 that were made from polyoxymethylene compositions that do not contain PEG. A higher value of percent retained tensile strength is evidence of higher abrasion resistance.

TABLE 8
Yarn-on Yarn Abrasion Properties of Monofilaments
with improved Abrasion Resistance

| Fiber | Formulation | Break Load | Break Load | % retained |
|---|---|---|---|---|
| Sample | Sample | (before abrasion) | (after abrasion) | tensile |
| Number | Number | N | N | strength |
| 16 | 9 | 23.92 | 20.13 | 84.2 |
| 18 | 11 | 22.23 | 19.33 | 87 |
| 1 | 1 | 30.04 | 27.11 | 90.2 |
| 19 | 12 | 32.23 | 31.06 | 96.4 |
| 20 | 2 | 30.7 | 28.74 | 94 |
| 21 | 13 | 27.96 | 27.45 | 98 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A monofilament fiber made from a polymer composition comprising a polyoxymethylene polymer blended with an abrasion additive, the abrasion additive comprising a polymer that has been meltblended with the polyoxymethylene polymer, the abrasion additive being present in an amount from about 0.05% to about 5% by weight, the monofilament fiber having an abrasion resistance of at least about 5,000 cycles prior to failure according to the wire-on-yarn test.

2. A monofilament fiber as defined in claim 1, further comprising a coupling agent.

3. A monofilament fiber as defined in claim 1, further comprising a thermoplastic elastomer.

4. A monofilament fiber as defined in claim 1, wherein the abrasion additive comprises a polyether.

5. A monofilament fiber as defined in claim 1, wherein the abrasion additive comprises a polyethylene glycol.

6. A monofilament fiber as defined in claim 1, wherein the abrasion additive comprises a polypropylene glycol.

7. A monofilament fiber as defined in claim 1, wherein the abrasion additive comprises polytetrafluoroethylene particles.

8. A monofilament fiber as defined in claim 1, wherein the abrasion additive comprises an oxidized polyethylene wax.

9. A monofilament fiber as defined in claim 1, wherein the abrasion additive comprises a bisstearamide.

10. A monofilament fiber as defined in claim 1, wherein the abrasion additive comprises a silicone oil.

11. A monofilament fiber as defined in claim 1, wherein the abrasion additive comprises a graft copolymer of a low density polyethylene and polystyrene-acrylonitrile.

12. A monofilament fiber as defined in claim 1, wherein the fiber has a diameter of greater than about 0.1 mm, preferably from 0.1 mm to 1.0 mm.

13. A monofilament fiber as defined in claim 1, wherein the coupling agent comprises an isocyanate, the coupling agent being present in the fiber in an amount from about 0.3% to about 3% by weight.

14. A monofilament fiber as defined in claim 1, wherein the thermoplastic elastomer comprises a thermoplastic polyurethane elastomer, the thermoplastic polyurethane elastomer being present in the fiber in an amount from about 0.5% to about 30% by weight.

15. A forming fabric for a papermaking process comprising a woven fabric comprising the monofilament fiber defined in claim 1.

16. A fishing accessory comprising:
a spool defining a core;
a fishing line wound around the core of the spool, the fishing line comprising the monofilament fiber defined in claim 1.

17. A monofilament fiber as defined in claim 6, wherein the polyoxymethylene polymer includes terminal groups and wherein at least about 50% of the terminal groups comprise hydroxyl groups.

18. A brushing device comprising:
a base and a plurality of brushing elements, the brushing elements comprising the monofilament fiber defined in claim 1.

19. A racket string comprising the monofilament fiber defined in claim 1.

20. A monofilament fiber made from polymer composition comprising a polyoxymethylene polymer, a thermoplastic elastomer, and a coupling agent, the thermoplastic elastomer being present in the polymer composition in an amount from about 0.5% by weight to less than 30% by weight, and the coupling agent being present in the polymer composition in an amount form 0.5% by weight to less than 1.0% by weight.

21. A monofilament fiber as defined in claim 20, wherein the polyoxymethylene polymer includes hydroxyl terminal groups and has a molecular weight of from about 4,000 g/mol to about 20,000 g/mol.

22. A monofilament fiber as defined in claim 20, wherein the polyoxymethylene polymer has a molecular weight of greater than about 20,000 g/mol.

23. A forming fabric for a papermaking process comprising a woven fabric comprising the monofilament fiber defined in claim 20.

24. A fishing accessory comprising:
a spool defining a core;
a fishing line wound around the core of the spool, the fishing line comprising the monofilament fiber defined in claim 20.

25. A brushing device comprising bristles, the bristles comprising the monofilament fiber defined in claim 20.

26. A monofilament fiber as defined in claim 20, wherein the fiber has a diameter of from about 0.1 mm to about 1.0 mm.

27. A monofilament fiber as defined in claim 20, wherein the fiber comprises a continuous filament.

28. A monofilament fiber as defined in claim 20, wherein the polyoxymethylene polymer includes terminal groups and wherein at least about 50% of the terminal groups comprise hydroxyl groups.

29. A monofilament fiber made from a polymer composition comprising a polyoxymethylene polymer blended with an abrasion additive, the abrasion additive comprising a polymer that has been meltblended with the polyoxymethylene polymer, the abrasion additive being present in an amount from about 0.05% to about 5% by weight, the monofilament fiber having an abrasion resistance according to a yarn on yarn test of greater than about 90% retained tensile strength.
